(19) United States
(12) Patent Application Publication
(10) Pub. No.: US 2022/0391149 A1
(43) Pub. Date: Dec. 8, 2022

(54) AUTHORIZED COMMUNICATION OF APPARATUS DATA OVER A NETWORK

(71) Applicant: Hewlett-Packard Development Company, L.P., Spring, TX (US)

(72) Inventors: Matthew Russell Tollestrup, San Diego, CA (US); Shell S. Simpson, Boise, ID (US); Roger S. Twede, Boise, ID (US)

(21) Appl. No.: 17/755,991

(22) PCT Filed: Dec. 20, 2019
(86) PCT No.: PCT/US2019/068134

§ 371 Date: May 13, 2022

(51) Int. Cl. G06F 3/12; H04L 9/40

(52) U.S. Cl. CPC G06F 3/1204; H04L 63/0876; G06F 3/1229; G06F 3/1236

(57) ABSTRACT

According to examples, an apparatus may include a processor and a memory on which may be stored instructions that when executed by the processor, may cause the processor to access first identification information associated with the apparatus and send a portion of the first identification information to a server. A list of second identification information may be received from the server having portions that match the sent portion of the first identification information. In some examples, the processor may determine that the apparatus is authorized to communicate apparatus data of the apparatus to a services provider server based on a determination that the first identification information matches a second identification information among the received list of second identification information. Based on a determination that the apparatus is authorized to communicate the apparatus data, the processor may communicate the apparatus data over a network to the services provider server.

### BACKGROUND

Electronic apparatuses, such as printers and multi-function apparatuses, may communicate data about the apparatuses to servers that may base the provision of services to the electronic apparatuses based on the received data. For instance, the servers may track supply level information at the printer (e.g., toner levels) and may determine that a new toner cartridge is to be mailed to an operator of the printer based on the tracked supply level information indicating that the toner levels are low. As other examples, the servers may track when the electronic apparatuses are to undergo routine maintenance and/or billing arrangements for the electronic apparatuses according to contractual terms based on the received data. In some examples, users of the electronic apparatuses may provide consent prior to the data being communicated to the servers.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may communicate apparatus data to a services provider server based on a determination that the apparatus is authorized, e.g., that consent exists, for the communication of the apparatus data;

FIG. 2 shows a block diagram of an example system in which the example apparatus depicted in FIG. 1 may be implemented;

FIG. 3 shows a flow diagram of an example method for generating at a server a list of second identification information associated with apparatuses that include portions that match a portion of a first identification information received from an apparatus; and

FIG. 4 shows a block diagram of an example non-transitory computer readable medium that may have stored thereon machine readable instructions to communicate printer data to a services provider server based on a determination that consent exists for the printer data to be communicated to the services provider server.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Electronic apparatuses, such as printers, multifunction machines, etc., may be set up such that a services provider server may provide services for the apparatuses based on data that the apparatuses communicate to the services provider server. In some examples, customers of a services provider may enter into an agreement with the services provider to provide services such as billing, supply reordering, maintenance scheduling, and/or the like based on apparatus data supplied to the services provider. The apparatus data may include, for instance, number of pages printed, supply levels, event logs, and/or the like.

Generally speaking, a user of an apparatus may provide authorization, consent, and/or the like for the apparatus data to automatically be communicated to the services provider. Without such consent, the apparatus may not automatically communicate the apparatus data as such communication may violate data privacy regulations. In some instances, a user may be required to provide the consent each time that the apparatus data is to be communicated in order to comply with data privacy regulations. As the interface on the apparatus may be relatively small and/or limited, users may find it difficult to provide the consent via the interface, which may result in the users failing to provide the consent and the failure in the apparatus data from being communicated.

Disclosed herein are apparatuses, methods, and computer readable mediums that may obviate a requirement that the user of the apparatus provide such consent prior to the apparatus data being communicated to a services provider server. For instance, a processor may determine whether the user of the apparatus has provided consent based on a determination as to whether a first identification information matches a second identification information among second identification information included in a list of second identification information received from a server. That is, the processor may identify or generate a portion of the first identification information to be sent to the server, in which the portion of the first identification information may not uniquely identify the apparatus. As such, the processor may send the portion of the first identification information to the server without compromising the identity of the apparatus.

The server may identify second identification information that each includes portions that match the received portion of the first identification information, in which the second identification information are each associated with an apparatus for which consent exists for the apparatus to communicate apparatus data to the services provider server. In addition, the server may send a list of the identified second identification information to the processor. The second identification information may include information that matches the first identification information and may also include additional information that is not associated with the apparatus. As a result, the identity of the apparatus may not be easily determined from the list of second identification information. The communications between the processor and the server may thus protect the identity of the apparatus, which may enable the communications to comply with data privacy regulations.

In addition, the processor may determine whether first identification information matches any of the second identification information included in the list. Based on a determination that the first identification information matches one of the second identification information included in the list, the processor may determine that consent exists for the apparatus to communicate apparatus data to the services provider server. However, the processor may determine that consent does not exist for the apparatus to communicate apparatus data to the services provider server based on a determination that the first identification information does not match any of the second identification information included in the list. In addition, based on a determination that the consent exists, the processor may communicate the apparatus data over a network to the services provider server.

Through implementation of the features of the present disclosure, a processor may determine whether consent for automatic communication of apparatus data to a services provider server exists in a manner that may not cause an identity of the apparatus to be communicated. In addition, based on the processor determining that consent exists, the processor may communicate the apparatus data to the service provider server without first waiting for a user to provide the consent. As such, for instance, the processor may not be required to interact with a user to obtain the consent and may thus operate in an energy efficient and resource efficient manner. That is, the processor may determine that consent exists and may communicate the apparatus data without user input, which may enable the apparatus data to be communicated to the services provider server according to a predefined schedule. Following the predefined schedule may also enable the apparatus to operate efficiently, for instance, by undergoing regularly scheduled maintenance, the apparatus may operate in an energy efficient manner and may reduce the consumption of wasted resources such as ink, toner, paper, and/or the like.

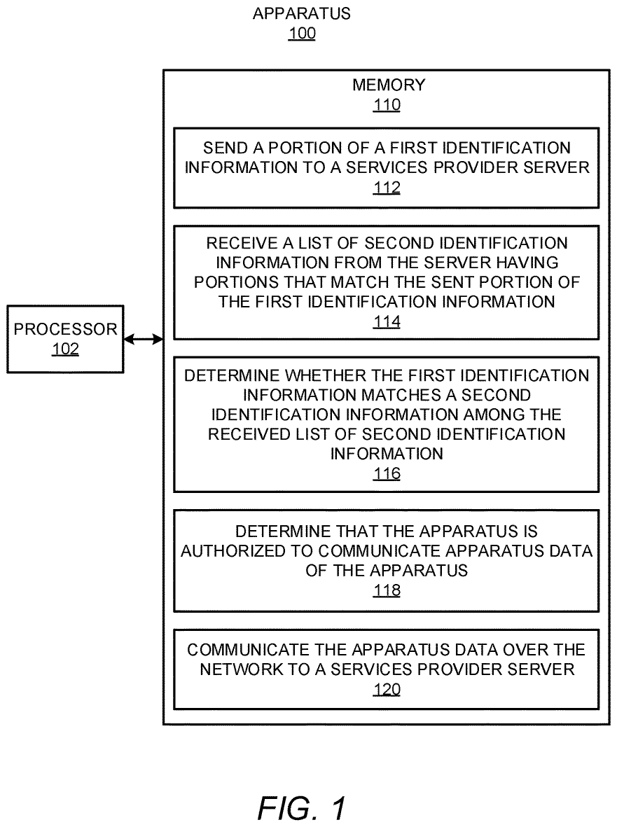

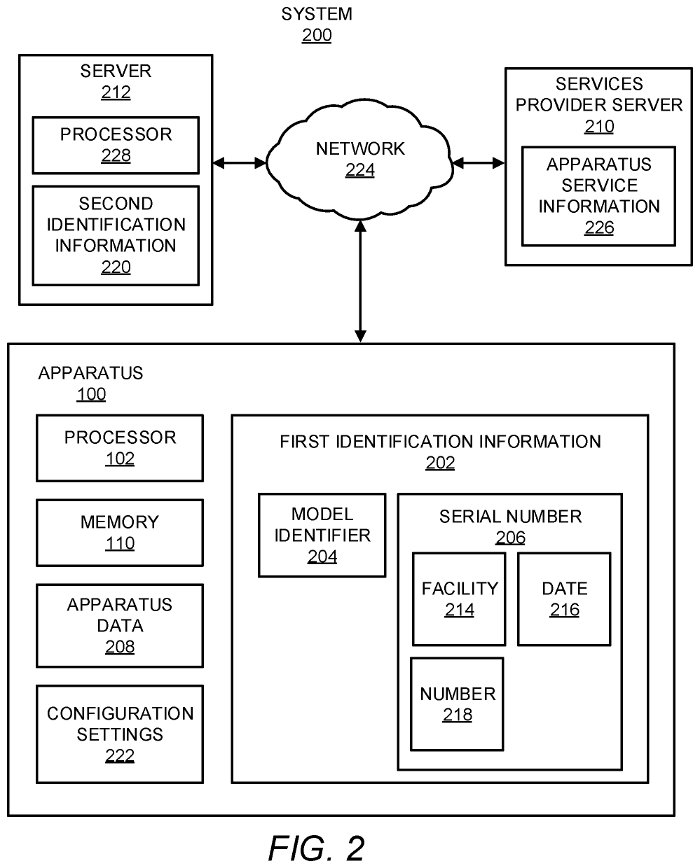

Reference is made to FIGS. 1 and 2. FIG. 1 shows a block diagram of an example apparatus 100 that may communicate apparatus data to a services provider server 210 based on a determination that the apparatus 100 is authorized, e.g., that consent exists, for the communication of the apparatus data 208. FIG. 2 shows a block diagram of an example system 200 in which the example apparatus 100 depicted in FIG. 1 may be implemented. It should be understood that the example apparatus 100 depicted in FIG. 1 and the example system 200 depicted in FIG. 2 may include additional features and that some of the features described herein may be removed and/or modified without departing from the scopes of the apparatus 100 and/or the system 200.

The apparatus 100 may be a personal computer, a laptop computer, a tablet computer, a smartphone, a two-dimensional printer, a three-dimensional printer, a server, a node in a network (such as a data center), a network gateway, a network router, an electronic device such as Internet of Things (IoT) device, a robotic device, and/or the like. As shown, the apparatus 100 may include a processor 102 and a non-transitory computer readable medium, e.g., a memory 110. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100. In this regard, references to a single processor 102 as well as to a single memory 110 may be understood to additionally or alternatively pertain to multiple processors 102 and/or multiple memories 110.

The memory 110 may be an electronic, magnetic, optical, or other physical storage device that contains or stores executable instructions. The memory 110 may be, for example, Read Only Memory (ROM), flash memory, solid state drive, Random Access memory (RAM), an Electrically Erasable Programmable Read-Only Memory (EEPROM), a storage device, an optical disc, or the like. The memory 110 may be a non-transitory computer readable medium. The term “non-transitory” does not encompass transitory propagating signals.

As shown in FIG. 1, the processor 102 may execute instructions 112-120 to communicate apparatus data of the apparatus 100 over a network to a services provider server based on the communication being authorized and/or consented to by a user. The instructions 112-120 may be machine-readable instructions, e.g., non-transitory computer readable instructions. In other examples, the apparatus 100 may include hardware logic blocks or a combination of instructions and hardware logic blocks to implement or execute functions corresponding to the instructions 112-120.

The processor 102 may fetch, decode, and execute the instructions 112 to send a portion of a first identification information 202 associated with the apparatus 100 to a server 212. For instance, the processor 102 may access the first identification information 202 associated with the apparatus 100, which may be stored on the memory 110, stored on a server, or stored in another type of storage apparatus. The first identification information 202 may be stored on the memory 110 at a factory at which the apparatus 100 is fabricated, by an operator of the apparatus 100, an owner of the apparatus 100, a seller of the apparatus 100, and/or the like, to enable distinguishable identification of the apparatus 100 with respect to other apparatuses. In any regard, the first identification number 202 may include a serial number and may uniquely identify the apparatus 100.

Generally speaking, the apparatus 100 may be connected to a services provider server 210 over a network 224 to obtain particular services for the apparatus 100. The services provider server 210 may be a server of a web services provider and may include one or a group of servers that provide services to apparatuses over a network. In some examples, an apparatus 100 may communicate apparatus data 208 to the services provider server 210 in order for the services provider server 210 to provide various types of services to the apparatus. By way of particular example, in a case where the apparatus 100 is a printer, the apparatus data 208 may include a number of pages printed, supply levels, event logs, and/or the like. Based on the received apparatus data 208, the services provider server 210 may provide services such as billing based on the number of pages printed, re-ordering of supplies or parts, scheduling of maintenance service based on events in the event logs, and/or the like. The services may be those for which a user, e.g., an owner, an operator, and/or the like, of the apparatus 100 may have contracted with a user, e.g., an owner, an operator, a manager, and/or like of the services provider server 210.

In some examples, the user of the apparatus 100 may have provided consent, authorization, etc., for the apparatus 100 to automatically communicate the apparatus data 208 to the services provider server 210. For instance, the user of the apparatus 100 may have provided the consent, authorization, etc., during the initiation of the contract with the owner and/or operator of the services provider server 210 and/or at another time following the initiation of the contract. However, in order to comply with privacy regulations such as the General Data Protection Regulation (GDPR), a user of the apparatus 100 may provide consent at each instance prior to the apparatus 100 communicating the apparatus data 208 over the network 224 to the services provider server 210.

As discussed herein, a requirement that the user of the apparatus 100 provide such consent may be obviated through implementation of various features of the present disclosure. For instance, the processor 102 may determine whether the user of the apparatus 100 has provided consent based on a determination as to whether the first identification information 202 matches a second identification information 220 as also discussed herein. The matching of the first identification information 202 to the second identification information 220 may be viewed as an indication that the user has consented to the apparatus 100 communicating the apparatus data 208 while a mismatch may be viewed as an indication that such consent may be lacking. In instances in which the processor 102 has indicated that such consent may be lacking, the processor 102 may not automatically communicate the apparatus data 208 to the services provider server 210.

By way of particular example, the processor 102 may obtain user consent by displaying prompts and receiving inputs through a user interface on the apparatus 100. In some cases, the user interface on the apparatus 100 may be small or limited. Alternatively or additionally, a large number of questions for the user may be needed to set up the apparatus 100 to automatically communicate the apparatus data 208. Such conditions may cause difficulties in obtaining user consent through the interface of the apparatus 100. Furthermore, in cases where user participation is needed to obtain consent and to set up the apparatus 100, additional user training and/or technical support may be required to enable proper configuration and setup. Through implementation of various features of the present disclosure, the user of the apparatus 100 may avoid having to provide consent, e.g., through the user interface of the apparatus 100, multiple times for the apparatus 100 to automatically communicate the apparatus data 208 to the services provider server 210 while still being in compliance with regulations, such as data privacy regulations.

As shown in FIG. 2, the first identification information 202 may include various types of information. For instance, the first identification information 202 may include a model identifier 204 (e.g., a model number) and a serial number 206. The combination of the model identifier 204 and the serial number 206 may uniquely identify the apparatus 100, e.g., may distinguish the apparatus 100 from other apparatuses. As discussed herein, in order to ensure that information communicated from the apparatus 100 does not include sensitive or uniquely identifiable information, the processor 102 may execute the instructions 112 to send only a portion of the first identification information 202 to the services provider server 210.

The serial number 206 may be made up of multiple parts, each part encoding different information associated with the apparatus 100. In some examples, the serial number 206 may include a part that encodes a manufacturing facility 214 associated with the apparatus 100, a part that encodes a manufacturing date 216, a part that represents a unique number 218, and/or the like, for the apparatus 100. The manufacturing facility 214 may be an encoded value (e.g., numbers and/or letters) that represents a manufacturing facility at which the apparatus 100 was manufactured. The manufacturing date 216 may be an encoded value that represents a date of manufacture of the apparatus 100. The unique number 218 may be a sequence number that represents an order in which an apparatus was manufactured, and may be associated with a particular manufacturing facility and manufacturing date. In some examples, the processor 102 may generate the portion of the first identification information 202 based on a predefined combination of the model identifier 204, the facility 214, the date 216, and/or the number 218. In addition, or alternatively, the processor 102 may generate the portion of the first identification information 202 as a portion of a particular one of the model identifier 204, the facility 214, the date 216, and/or the number 218.

The processor 102 may fetch, decode, and execute the instructions 114 to receive a list of second identification information 220 from the server 212, in which each of the second identification information 220 in the list may include a portion that matches the sent portion of the first identification information 202. By way of particular example, the server 212 may provide a contract registry service and may store information regarding apparatuses under contract and authorized to communicate apparatus data 208 for the services provider server 210 to provide services as discussed herein. In some instances, the server 212 may be the same as or may differ from the services provider server 210.

The information stored on the server 212 may include model identifiers (e.g., model numbers), serial numbers, types of consent provided, whether the apparatuses are under contract, whether the apparatuses are currently reporting to a services provider server 210, or another appropriate type of information for the contract apparatuses. The server 212 may receive from the apparatus 100 the portion of first identification information 202 associated with the apparatus 100. Since the received information may be a portion of the first identification information 202, an identity of the apparatus 100 may remain anonymous to the server 212. Based on the received portion of the first identification information 202, the server 212 may filter the information stored on the server 212 to generate a list of second identification information 220 that each includes a portion that matches the received portion of the first identification information 202.

By way of particular example, when the received portion of the first identification information 202 includes the model identifier 204 and a manufacturing facility 214, the server 212 may generate a list of all of the stored second identification information 220 having a matching model identifier and which were manufactured at the matching manufacturing facility. The server 212 may filter the second identification information 220 based on whether the apparatuses to which the second identification information 220 are respectively associated are authorized to communicate apparatus data 208 to the services provider server 210 (e.g., are apparatuses that are under contract), are not currently communicating apparatus data 208 to the services provider server 210 (e.g., are non-reporting apparatuses), have a matching model identifier, have a matching part of the serial number, and/or the like.

The list of second identification information 220 generated at the server 212 based on the received portion of the first identification information 202 may include the second identification information 220 of a plurality of apparatuses. In some examples, the generated list may include second identification information 220 associated with the apparatuses for which consent for the collection and transmission of apparatus data 208 to the services provider server 210 has been received. The second identification information 220 may be serial numbers of filtered apparatuses and may uniquely identify the apparatuses associated with the second identification information 220 included in the list.

A number of the second identification information 220 included in the list of second identification information 220 generated at the server 212 may be dependent on the portion, e.g., the predefined combination, of the first identification information 202 received from the apparatus 100. For example, filtering the stored apparatuses using the model identifier 204 may return a list that includes the second identification information 220 of all of the apparatuses of a particular model, while combining the model identifier 204 with one or more portions of the serial number 206 may narrow down the filtered results.

In some examples, the number of second identification information 220 included in the list may be maintained at a predefined minimum number (or threshold), in order to maintain anonymity of the apparatus 100. In some examples, the server 212 and the apparatus 100 may communicate with each other in order to adjust the portion of the first identification information 202 to ensure that the number of apparatuses included in the list is above the predefined minimum number. In some examples, when the number of apparatuses is less than the predefined minimum number, the server 212 may generate and include fake second identification information to ensure the number of second identification information 220 included in the list is above the predefined minimum number. For example, the server 212 may generate random serial numbers for inclusion in the list. As another example, the server 212 may include a number of second identification information in the list that do not include portions that match the received portion of the first identification information 202.

In some examples, the processor 102 may fetch, decode, and execute the instructions 116 to determine whether the first identification information 202 matches a second identification information 220 among the received list of second identification information 220. The processor 102 may compare the entire first identification information 202, which may uniquely identify the apparatus 100, with each of the second identification information 220 included in the received list. In some examples, the processor 102 may compare the model identifier 204 and/or each part 214, 216, and 218 of the serial number 206 with each of the second identification information 220 in the list received from the server 212.

The processor 102 may fetch, decode, and execute the instructions 118 to determine that the apparatus 100 is authorized, e.g., that a user of the apparatus 100 has consented, to communicate apparatus data 208 to the services provider server 210 based on a determination that the first identification information 202 matches a second identification information 220 in the received list of second identification information 220. As previously described, the second identification information 220 in the list may be serial numbers for a plurality of apparatuses, and the processor 102 may determine that consent for collection and transmission of apparatus data 208 exists and/or is currently in force when the serial number 206 matches a serial number in the received list of serial numbers.

In addition, based on a determination that the first identification information 202 does not match any of the second identification information 220 in the received list of second identification information 220, the processor 102 may determine that the apparatus 100 is not authorized to communicate apparatus data 208 to the services provider server 210. That is, the processor 102 may determine that a consent of a user of the apparatus 100 is not currently enforceable and may determine that the user of the apparatus 100 provide consent again.

Once consent has been determined to exist, the processor 102 may adjust configuration settings 222 of the apparatus 100 to enable the apparatus 100 to connect with the services provider server 210. For instance, the processor 102 may update the configuration settings 222 to include network address information for the services provider server 210 so that a communication session to the services provider server 210 may be established. In addition, the processor 102 may set up the firmware and/or software of the apparatus 100 that performs the transmission of the apparatus data 208. In some examples, the processor 102 may identify types of data to be collected for transmission to the services provider server 210. The processor 102 may also update the configuration settings 222 to set when the collected apparatus data 208 may be communicated over the network 224, e.g., frequency, schedule, or the like.

The processor 102 may fetch, decode, and execute the instructions 120 to, based on a determination that the apparatus is authorized to communicate the apparatus data 208, communicate the apparatus data 208 over the network 224 to the services provider server 210. For instance, the processor 102 may cause the apparatus 100 to collect the apparatus data 208 and to communicate the collected apparatus data 208 to the services provider server 210 at a predetermined time while being in compliance with data privacy regulations.

In some examples, the services provider server 210 may provide apparatus service information 226 to the apparatus 100. The apparatus service information 226 may include information regarding the consent for data transmission, including the type of service and consented behavior to support the service. The apparatus service information 226 may define the type and amount of apparatus data 208 to be collected and sent from the apparatus 100. By way of particular example, in a case where the apparatus 100 is a printer, the processor 102 may determine, based on the apparatus service information 226, that the type of service is billing and supply reordering, and the apparatus data 208 to be collected are a number of pages printed and supply levels. In some examples, the processor 102 may determine whether other types of apparatus data 208, which may be considered sensitive such as payment information, user name, address, and/or the like, may also be collected based on the apparatus service information 226.

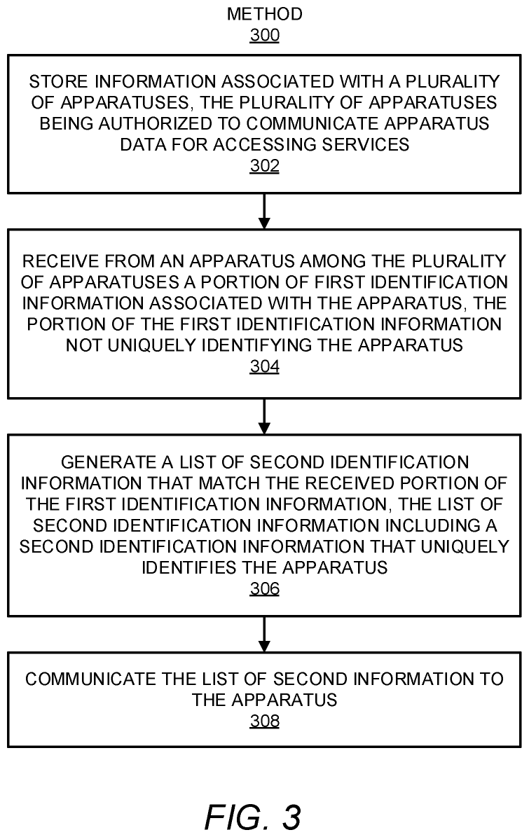

Turning now to FIG. 3, there is shown a flow diagram of an example method 300 for generating at a server 212 a list of second identification information 220 associated with apparatuses that include portions that match a portion of a first identification information 202 received from an apparatus 100. It should be understood that the method 300 depicted in FIG. 3 may include additional operations and that some of the operations described therein may be removed and/or modified without departing from the scope of the method 300. The description of the method 300 is also made with reference to the features depicted in FIGS. 1-2 for purposes of illustration. Particularly, the server 212 may include similar components as the apparatus 100 and may include a processor 228 that may execute some or all of the operations included in the method 300, and the processor 228 may generate a list of second identification information 220 based on a portion of the first identification information 202 received from the apparatus 100, as previously described.

At block 302, the processor 228 may store information associated with a plurality of apparatuses, e.g., on the server 212 and/or a storage device that the server 212 may access. The plurality of apparatuses may be apparatuses 100 that have been authorized, e.g., for which users have provided consent, to communicate apparatus data 208 for accessing services from a services provider server 210. In some examples, the server 212 may store information fora subset of apparatuses, such as contract apparatuses that are non-reporting (e.g., not currently communicating with the services provider server 210). The information for the apparatuses stored on the server 212 may include the serial numbers of the apparatuses, model identifiers, and/or the like. In some examples, the information may uniquely identify each of the apparatuses, or alternatively or additionally, the information may identify a group of apparatuses for which consent for data collection/transmission was previously given and with which a requesting apparatus may confirm the consent.

At block 304, the processor 228 may receive, from an apparatus 100 among the plurality of apparatuses, a portion of a first identification information 202 associated with the apparatus 100. The portion of the first identification information 202 may omit parts of the first identification information 202 such that the portion does not uniquely identify the apparatus 100. In some examples, the received portion of the first identification information 202 may include a model identifier 204 of the apparatus 100 and/or a part of a serial number 206 of the apparatus 100.

At block 306, the processor 228 may generate a list of second identification information 220 that each includes a portion that matches the received portion of the first identification information 202. The processor 102 may filter the information associated with the plurality of apparatuses based on the model identifier 204 and/or the part of the serial number 206 of the apparatus 100. In some examples, the part of the serial number 206 of the apparatus 100 may include a part that encodes a manufacturing facility 214, a part that encodes a manufacturing date 216, and/or a part that represents a unique number 218 for the apparatus 100. The filtered information may identify second identification information 220 associated with the apparatuses that may be authorized to communicate apparatus data to the services provider server 210 (e.g., consent given), are not currently communicating apparatus data to the services provider server 210 (e.g., is a non-reporting apparatus), have a matching model identifier 204, have a matching part of the serial number 206, and/or the like.

The generated list of second identification information 220 may include second identification information 220 that uniquely identifies the apparatus 100 that sent the portion of the first identification information 202. In some examples, the second identification information 220 may be serial numbers that may uniquely identify each apparatus to which the second identification information are respectively associated.

In some examples, the processor 228 may determine whether the list of second identification information 220 includes second identification information 220 for a predefined minimum number of apparatuses, e.g., a predefined minimum number of entries. Ensuring that the list includes a minimum number of apparatuses may preserve the anonymity of the requesting apparatus 100. In some instances, based on a determination that the list of second identification information 220 does not include the predefined minimum number of entries, the processor 102 may add fake second identification information 220 to ensure that the list has the predefined minimum number of apparatuses. The fake second identification information 220 may include, for instance, randomly selected information, information that does not include portions that match the portion of the first identification information 202, and/or the like.

At block 308, the processor 228 may communicate the list of second identification information 220 to the apparatus 100 that communicated the portion of the first identification information 202. The apparatus 100 may then determine whether a match exists in the list for the first identification information 202, in order to confirm consent for apparatus data 208 collection and transmission, as previously described with respect to FIGS. 1 and 2.

Some or all of the operations set forth in the method 300 may be included as utilities, programs, or subprograms, in any desired computer accessible medium. In addition, the method 300 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic apparatus capable of executing the above-described functions may perform those functions enumerated above.

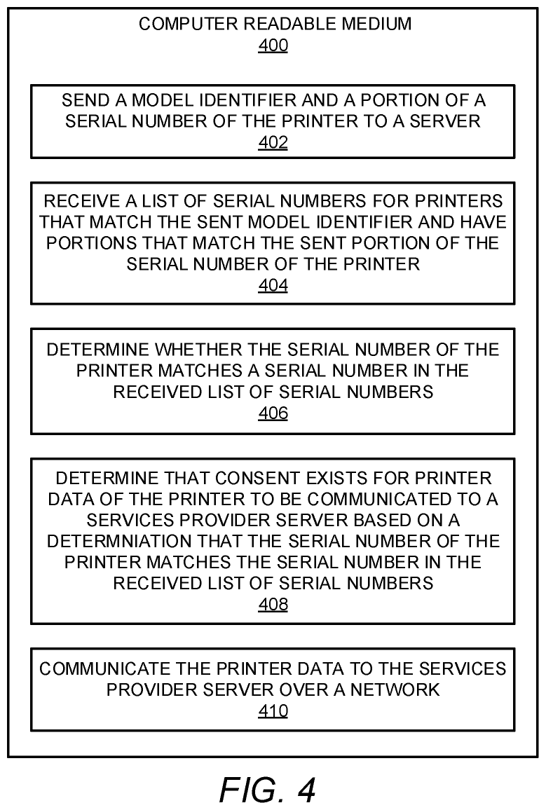

Turning now to FIG. 4, there is shown a block diagram of an example non-transitory computer readable medium 400 that may have stored thereon machine readable instructions to communicate printer data 208 to a services provider server 210 based on a determination that consent exists for the printer data 208 to be communicated to the services provider server 210. In some examples, the printer may be the apparatus 100 as previously described. It should be understood that the computer readable medium 400 depicted in FIG. 4 may include additional instructions and that some of the instructions described herein may be removed and/or modified without departing from the scope of the computer readable medium 400 disclosed herein. The computer readable medium 400 may be a non-transitory computer readable medium. The term “non-transitory” does not encompass transitory propagating signals. The description of the non-transitory computer readable medium 400 is also made with reference to the features depicted in FIGS. 1-2 for purposes of illustration. Particularly, the processor 102 of the apparatus 100 may execute some or all of the instructions 402-410 included in the non-transitory computer readable medium 400.

The computer readable medium 400 may have stored thereon machine readable instructions 402-410 that a processor, such as the processor 102 depicted in FIGS. 1 and 2, may execute. Particularly, the processor 102 may execute instructions 402 to send a model identifier 204 and a portion of a serial number 206 of the printer 100 to a server 212. That is, for instance, the processor 102 may access first identification information 202 associated with the printer 100 and may identify the model identifier 204 and the portion of the serial number 206 from the accessed first identification information 202.

The processor 102 may execute the instructions 404 to receive, from the server, a list of serial numbers for printers that match the sent model identifier 204 and have portions that match the sent portion of the serial number 206 of the printer 100. The list may also include second identification information 220, which in some examples may include model identifiers, and/or another type of identification information associated with the printers. The processor 102 may execute the instructions 406 to determine whether the serial number 206 of the printer 100 matches a serial number in the received list of serial numbers. The processor 102 may execute the instructions 408 to determine that consent exists for printer data 208 of the printer 100 to be communicated to a services provider server 210 based on a determination that the serial number 206 of the printer 100 matches the serial number in the received list of serial numbers. The processor 102 may execute the instructions 410 to, based on a determination that the consent exists, communicate the printer data 208 over the network 224 to a services provider server 210 over the network 224.

In some examples, the processor 102 may generate the portion of the serial number 206 of the printer 100 to be sent to the server 212 while ensuring that the portion of the serial number 206 does not uniquely identify the printer 100. In some instances, instead of the portion of the serial number 206, the processor 102 may generate a predefined combination of parts that encodes a manufacturing facility 214, a manufacturing date 216, and/or a unique number 218 for the printer 100 associated with the manufacturing facility 214 and the manufacturing date 216. In these instances, the processor 102 may send the predefined combination of parts to the server 212.

In some examples, the processor 102 may determine whether the printer 100 is initially turned on, and based on a determination that the printer 100 is initially turned on, the processor 102 may generate the predefined combination of the parts and/or the portion of the serial number 206 of the printer 100 for transmission to the server 212. Alternatively or additionally, the processor 102 may determine other events that may confirm whether consent for the printer 100 to communicate the apparatus data 208 to the services provider server 210 exists. In some examples, the processor 102 may determine that consent exists as described herein following an initial power on event, periodically based on a predefined interval of time, based on a request by a user or a services provider, or another appropriate type of trigger or event.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which are stored machine readable instructions that when executed by the processor, cause the processor to:
send a portion of a first identification information associated with the apparatus to a server;
receive, from the server, a list of second identification information that each includes a portion that matches the portion of the first identification information;
determine whether the first identification information matches a second identification information among the received list of second identification information; and
determine that the apparatus is authorized to communicate apparatus data of the apparatus to a services provider server based on a determination that the first identification information matches a second identification information among the received list of second identification information; and
based on a determination that the apparatus is authorized to communicate the apparatus data, communicate the apparatus data over a network to the services provider server.

2. The apparatus of claim 1, wherein the portion of the first identification information does not uniquely identify the apparatus, and wherein the second identification information that matches the first identification information uniquely identifies the apparatus.

3. The apparatus of claim 1, wherein the first identification information includes a model identifier of the apparatus and/or a serial number of the apparatus.

4. The apparatus of claim 3, wherein the serial number of the apparatus includes a part that encodes a manufacturing facility, a part that encodes a manufacturing date, and/or a part that represents a unique number for the apparatus, and
wherein the portion of the first information includes a predefined combination of the model identifier, the part that encodes the manufacturing facility, the part that encodes the manufacturing date, and/or the part that represents the unique number for the apparatus.

5. The apparatus of claim 1, wherein the received list of second identification information comprises a list of serial numbers for a predefined minimum number of apparatuses that match the sent portion of the first identification information.

6. The apparatus of claim 1, wherein the instructions cause the processor to:
determine whether the apparatus is initially turned on; and
based on a determination that the apparatus is initially turned on, identify the portion of the first identification information to be sent to the server.

7. The apparatus of claim 1, wherein the instructions cause the processor to:
based on the determination that the first identification information matches a second identification information among the received list of second identification information, send a request to the services provider server for apparatus service information, the apparatus service information identifying types of apparatus data authorized for communication, and configure the apparatus to communicate apparatus data for accessing services in compliance with the authorized types of apparatus data.

8. A method comprising:
storing, by a processor, information associated with a plurality of apparatuses, the plurality of apparatuses being authorized to communicate apparatus data for accessing services from a services provider server;
receiving, by the processor from an apparatus among the plurality of apparatuses, a portion of a first identification information associated with the apparatus, wherein the portion of the first identification information does not uniquely identify the apparatus;
generating, by the processor, a list of second identification information that each includes a portion that matches the received portion of the first identification information, the list of second identification information including a second identification information that uniquely identifies the apparatus; and
communicating, by the processor, the list of second identification information to the apparatus.

9. The method of claim 8, wherein the received portion of the first identification information includes a model identifier of the apparatus and/or a part of a serial number of the apparatus.

10. The method of claim 9, further comprising:
filtering the information associated with the plurality of apparatuses based on the model identifier and/or the part of the serial number of the apparatus, the part of the serial number of the apparatus comprising a part that encodes a manufacturing facility, a part that encodes a manufacturing date, and/or a part that represents a unique number for the apparatus.

11. The method of claim 9, further comprising:
filtering the information associated with the plurality of apparatuses based on the received portion of the first identification information associated with the apparatus, the filtered information identifying apparatuses that are authorized to communicate apparatus data to a service, are not currently communicating apparatus data to the service, have a matching model identifier, and have a matching part of the serial number.

12. The method of claim 9, further comprising:
determining whether the list of second identification information includes second identification information for a predefined minimum number of apparatuses; and
based on a determination that the list of second identification information does not include the predefined minimum number of apparatuses, adding fake second identification information to the list.

13. A non-transitory computer readable medium on which is stored machine readable instructions that, when executed by a processor, cause the processor to:
send a model identifier and a portion of a serial number of a printer to a server;
receive, from the server, a list of serial numbers for printers that match the sent model identifier and have portions that match the sent portion of the serial number of the printer;
determine whether the serial number of the printer matches a serial number in the received list of serial numbers;
determine that consent exists for printer data of the printer to be communicated to a services provider server based on a determination that the serial number of the printer matches the serial number in the received list of serial numbers; and,
based on a determination that the consent exists, communicate the printer data to the services provider server over a network.

14. The computer readable medium of claim 13, wherein the portion of the serial number of the printer sent to the server does not uniquely identify the printer, the portion of the serial number of the printer comprising a part that encodes a manufacturing facility, a part that encodes a manufacturing date, and/or a part that represents a unique number for the printer associated with the manufacturing facility and the manufacturing date.

15. The computer readable medium of claim 14, wherein the instructions are further to cause the processor to:
determine whether the printer is initially turned on; and
based on a determination that the printer is initially turned on, generate a predefined combination of the parts of the serial number of the printer to be sent to the server.
